(19) United States
(12) Patent Application Publication
(10) Pub. No.: US 2011/0291932 A1
(43) Pub. Date: Dec. 1, 2011

(54) COMPUTER MOUSE

(75) Inventors: XIANG CAO, Shenzhen (CN); ZHEN-XING YE, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/860,998

(22) Filed: Aug. 23, 2010

(30) Foreign Application Priority Data
May 28, 2010 (CN) 201020206609.1

(51) Int. Cl. G09G 5/08

(52) U.S. Cl. 345/166

(57) ABSTRACT

A computer mouse includes a control module and a light emitting module connected to the control module. When the light emitting module is connected to a power supply of a computer by the control module, the control module detects intensity of ambient light around the computer mouse and controls the light emitting module to turn on/off according to the detected ambient light intensity.

### BACKGROUND

1. Technical Field

The disclosure generally relates to computer mice, particularly to a lighted computer mouse that can use less electrical power.

2. Description of Related Art

Some computer mice may include a light source such as a light emitting diode (LED) positioned inside so that the mice can be easily found and grasped by a user in darkness and/or to make the mouse more attractive in low-light conditions. However, such light sources emit whenever the computer mouse is connected to a computer, thereby continuously consuming electrical power.

Therefore, there is room for improvement within the art.

### BRIEF DESCRIPTION OF THE DRAWINGS

Many aspects of the computer mouse can be better understood with reference to the following drawings. The components in the drawings are not necessarily drawn to scale, the emphasis instead being placed upon clearly illustrating the principles of the computer mouse.

FIG. 1 shows a schematic view of a computer mouse, according to an exemplary embodiment.

FIG. 2 shows a circuit diagram of a control module and a light emitting module of the computer mouse shown in FIG. 1.

### DETAILED DESCRIPTION

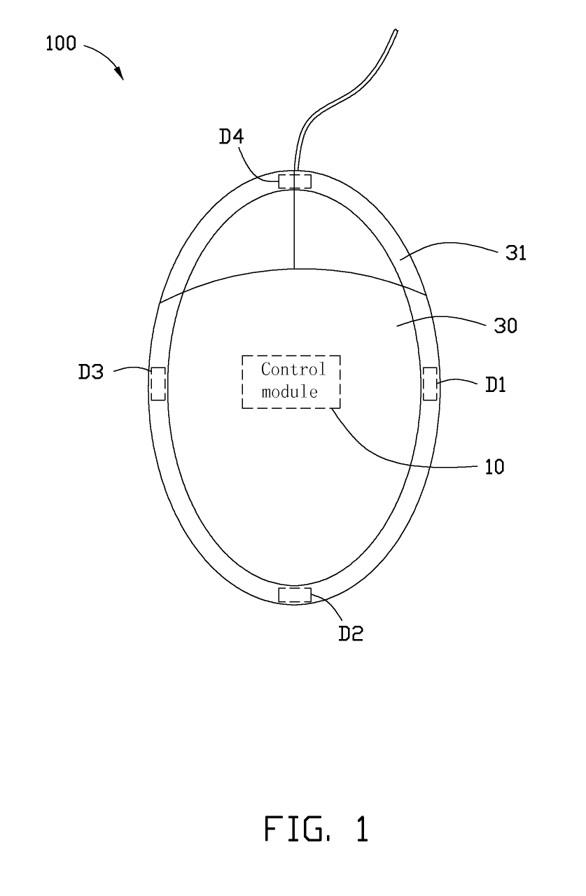

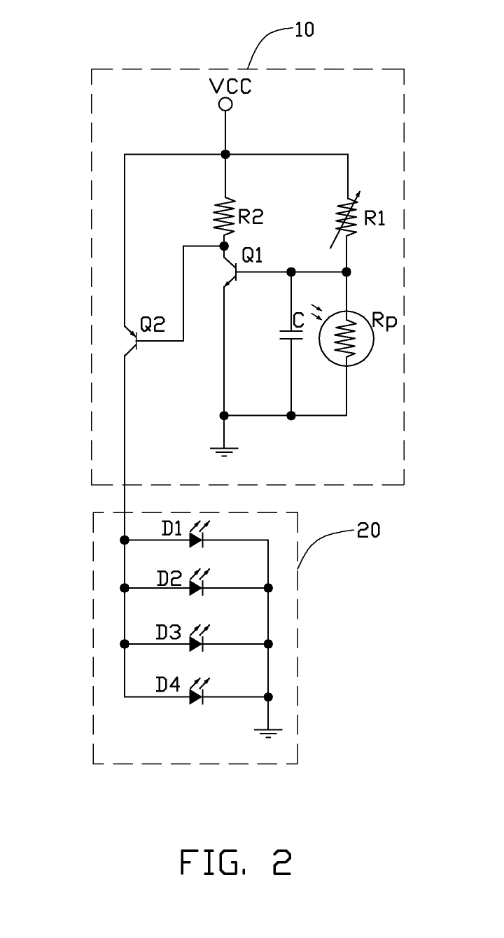

Referring to FIG. 1 and FIG. 2, a computer mouse 100 used with a computer to input information, according to an exemplary embodiment includes a control module 10, a light emitting module 20, and a housing 30. The control module 10 and the light emitting module 20 are positioned inside the housing 30. When the computer mouse 100 is connected to the computer, the light emitting module 20 is electrically connected to a power supply VCC of the computer by the control module 10. The control module 10 detects intensity of ambient light around the computer mouse 100, and controls the light emitting module 20 to emit light or not according to the ambient light intensity.

The control module 10 includes a photoresistor Rp, a first resistor R1, a second resistor R2, a first transistor Q1, a second transistor Q2, and a capacitor C. In this exemplary embodiment, the first transistor Q1 is an npn bipolar junction transistor, the second transistor Q2 is a pnp bipolar junction transistor. The photoresistor Rp and the first resistor R1 are connected in series between the power supply VCC and ground. The collector of the first transistor Q1 is connected to the power supply VCC by the second resistor R2. The base of the first transistor Q1 is connected to a node between the photoresistor Rp and the first resistor R1. The emitter of the first transistor Q1 is grounded. The emitter of the second transistor Q2 is connected to the power supply VCC. The base of the second transistor Q2 is connected to the collector of the first transistor Q1. The collector of the second transistor Q2 is connected to the light emitting module 20. The capacitor C is connected in parallel with the photoresistor Rp.

The light emitting module 20 includes a plurality of LEDs connected in parallel. In this exemplary embodiment, there are four LEDs D1˜D4. The anodes of the four LEDs D1˜D4 are connected to the collector of the second transistor Q2. The cathodes of the four LEDs D1˜D4 are grounded.

The housing 30 includes a light emitting portion 31. The light emitting portion 31 is transparent or semitransparent. In this exemplary embodiment, the light emitting portion 31 is positioned around at least one portion of the edge of a bottom surface of the housing 30. The four LEDs D1˜D4 of the exemplary embodiment are positioned inside the housing 30 corresponding to the light emitting portion 31 and can emit light through the light emitting portion 31.

In use, the mouse 100 is connected to a computer. The control module 10 is powered by the power supply VCC of the computer. The photoresistor Rp detects intensity of ambient light around any selected portions of the computer mouse 100. The resistance of the photoresistor Rp varies with the variation of the ambient light intensity. In this exemplary embodiment, the resistance of the photoresistor Rp deceases when the ambient light intensity increases. When the ambient light intensity decreases to a threshold value, the first and second transistor Q1 and Q2 are switched on to turn on the light emitting module 20. Correspondingly, when the ambient light intensity increases to the threshold value, the first and second transistor Q1 and Q2 are switched off to turn off the light emitting module 20. Therefore, the computer mouse 100 can save electrical power during times light from the light emitting module 20 would not be useful or needed. The threshold value of the light intensity can be adjusted by changing the resistance of the resistor R1.

The computer mouse 100 controls the light emitting module 20 to turn off when the ambient light intensity is equal to/higher than a threshold value, and can save electric power.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A computer mouse, comprising:
a control module; and
a light emitting module connected to the control module; wherein when the light emitting module is connected to a power supply of a computer by the control module, the control module detects intensity of ambient light around the computer mouse and controls the light emitting module to turn on/off according to the detected ambient light intensity.

2. The computer mouse as claimed in claim 1, wherein the control module includes a photoresistor, a first resistor, a second resistor, a first transistor and a second transistor; the photoresistor and the first resistor are connected in series between the power supply and ground; the collector of the first transistor is connected to the power supply by the second resistor; the base of the first transistor is connected to a node between the photoresistor and the first resistor; the emitter of the first transistor is grounded; the emitter of the second transistor is connected to the power supply; the base of the second transistor is connected to the collector of the first transistor; the collector of the second transistor is connected to the light emitting module.

3. The computer mouse as claimed in claim 2, wherein the first resistor is an adjustable resistor.

4. The computer mouse as claimed in claim 2, wherein the light emitting module includes a plurality of LEDs connected in parallel; the anodes of LEDs are connected to the collector of the second transistor; the cathodes of the LEDs are grounded.

5. The computer mouse as claimed in claim 1, further comprising a housing, wherein the control module and the light emitting module are positioned inside the housing.

6. The computer mouse as claimed in claim 5, wherein the housing includes a light emitting portion positioned around at least a portion of an edge of the bottom surface thereof; the light emitting module emits light through the light emitting portion.

7. The computer mouse as claimed in claim 6, wherein the ambient light emitting portion is transparent or semitransparent.

8. The computer mouse as claimed in claim 2, wherein when the detected ambient light intensity decreases to a threshold value, the first and second transistor and are switched on to turn on the light emitting module; when the ambient light intensity increase to the threshold value, the first and second transistor and are switched off to turn off the light emitting module.

9. The computer mouse as claimed in claim 8, wherein the threshold value of the ambient light intensity can be adjusted by changing the resistance of the first resistor.
